(19) United States
(12) Patent Application Publication
(10) Pub. No.: US 2026/0035127 A1
(43) Pub. Date: Feb. 5, 2026

(54) TRAY FOR FOOD PRODUCTS

(71) Applicant: Graphic Packaging International, LLC, Atlanta, GA (US)

(72) Inventor: Nellie Juan Pedicord, Oak Park, IL (US)

(21) Appl. No.: 19/286,796

(22) Filed: Jul. 31, 2025

Related U.S. Application Data
(60) Provisional application No. 63/678,097, filed on Aug. 1, 2024.

(51) Int. Cl. B65D 5/20; B31B 50/26; B31B 100/00; B31B 120/10; B65D 5/42; B65D 5/66

(52) U.S. Cl. CPC B65D 5/2057; B31B 50/262; B65D 5/4204; B65D 5/665; B31B 2100/00; B31B 2120/102

(57) ABSTRACT

A tray for holding one or more food products includes a base at least partially extending around an interior of the tray, the base having a base bottom panel, at least one base side panel, a base back panel, and a base front panel, and a lid foldably connected to the base such that the lid is repositionable between an open position and a closed position, the lid including a top panel, at least one lid side panel, and a lid front panel, and locking features for at least partially maintaining the closed position of the lid, the locking features comprising a locking tab extending from the at least one base side panel and a line of weakening in the at least one lid side panel at least partially defining a locking region for engaging the at least one locking tab.

### CROSS-REFERENCE TO RELATED APPLICATION

The present application claims the benefit of U.S. Provisional Patent Application No. 63/678,097, filed on Aug. 1, 2024.

### INCORPORATION BY REFERENCE

The disclosure of U.S. Provisional Patent Application No. 63/678,097, filed on Aug. 1, 2024, is hereby incorporated by reference for all purposes as if set forth in its entirety.

### BACKGROUND OF THE DISCLOSURE

The present disclosure generally relates to trays for holding one or more food products. In some embodiments, the present disclosure relates to trays for holding one or more food products that include locking features for at least partially maintaining the tray in a closed configuration.

### SUMMARY OF THE DISCLOSURE

According to one aspect, the disclosure is generally directed to a tray for holding one or more food products, the tray comprising a base at least partially extending around an interior of the tray, the base comprising a base bottom panel, at least one base side panel, a base back panel, and a base front panel, and a lid foldably connected to the base such that the lid is repositionable between an open position and a closed position, the lid comprising a top panel, at least one lid side panel, and a lid front panel, and locking features for at least partially maintaining the closed position of the lid, the locking features comprising a locking tab extending from the at least one base side panel and a line of weakening in the at least one lid side panel at least partially defining a locking region for engaging the at least one locking tab.

According to another aspect, the disclosure is generally directed to a blank for forming a tray for holding one or more food products, comprising a base portion for forming a base at least partially extending around an interior of the tray formed from the blank, the base portion comprising a base bottom panel, at least one base side panel, a base back panel, and a base front panel, and a lid portion foldably connected to the base for forming a lid when the tray is formed from the blank such that the lid is repositionable between an open position and a closed position, the lid comprising a top panel, at least one lid side panel, and a lid front panel, and locking features for at least partially maintaining the closed position of the lid when the tray is formed from the blank, the locking features comprising a locking tab extending from the at least one base side panel and a line of weakening in the at least one lid side panel at least partially defining a locking region for engaging the at least one locking tab.

According to another aspect, the disclosure is generally directed to a method of forming a tray for holding one or more food products, the method comprising obtaining a blank, the blank comprising a base portion comprising a base bottom panel, at least one base side panel, a base back panel, and a base front panel, the blank further comprising a lid portion foldably connected to the base portion, the lid portion comprising a top panel, at least one lid side panel, and a lid front panel, the blank further comprising locking features comprising a locking tab extending from the at least one base side panel and a line of weakening in the at least one lid side panel at least partially defining a locking region. The method further comprises forming a base from the base portion of the blank such that the base extends at least partially extending around an interior of the tray, and forming a lid from the lid portion of the blank such that the lid is repositionable between an open position and a closed position, and such that the locking region is positionable for engaging the at least one locking tab for at least partially maintaining the closed position of the lid.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank used to form a tray for holding one or more food products according to an exemplary embodiment of the disclosure.

FIG. 2 is a front perspective view of a tray formed from the blank of FIG. 1 in an open configuration according to an exemplary embodiment of the disclosure.

FIG. 3 is a rear perspective view of the tray of FIG. 2 according to an exemplary embodiment of the disclosure.

FIG. 4 is an enlarged upper perspective view of a portion of the tray of FIG. 2 in a closed configuration according to an exemplary embodiment of the disclosure.

FIG. 5 is an enlarged lower perspective view of a portion of the tray of FIG. 2 in a closed configuration according to an exemplary embodiment of the disclosure.

FIG. 6 is another enlarged lower perspective view of a portion of the tray of FIG. 2 in a closed configuration according to an exemplary embodiment of the disclosure.

FIG. 7 is another enlarged lower perspective view of a portion of the tray of FIG. 2 in a closed configuration according to an exemplary embodiment of the disclosure.

Corresponding parts are designated by corresponding reference numbers throughout the drawings.

### DETAILED DESCRIPTION OF THE EXEMPLARY EMBODIMENTS

Trays according to the present disclosure can accommodate articles of numerous different shapes. For the purpose of illustration and not for the purpose of limiting the scope of the disclosure, the following detailed description describes articles such as food products that may be provided in discrete portions, for example, chicken nuggets, chicken strips, French fries, chips, and/or other food items that can commonly be referred to as finger foods. Such food products can also include sandwiches or the like, for example, chicken sandwiches, hamburgers, tacos, burritos, etc. Other types of articles that can include food products and/or nonfood products can be placed in the tray for service to a customer without departing from the disclosure.

In some embodiments, food products can be provided in packaging made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; composite materials; and the like, or any combination thereof.

In this specification, the terms “lower,” “bottom,” “upper,” and “top” indicate orientations determined in relation to fully erected and upright trays. As described herein, trays can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

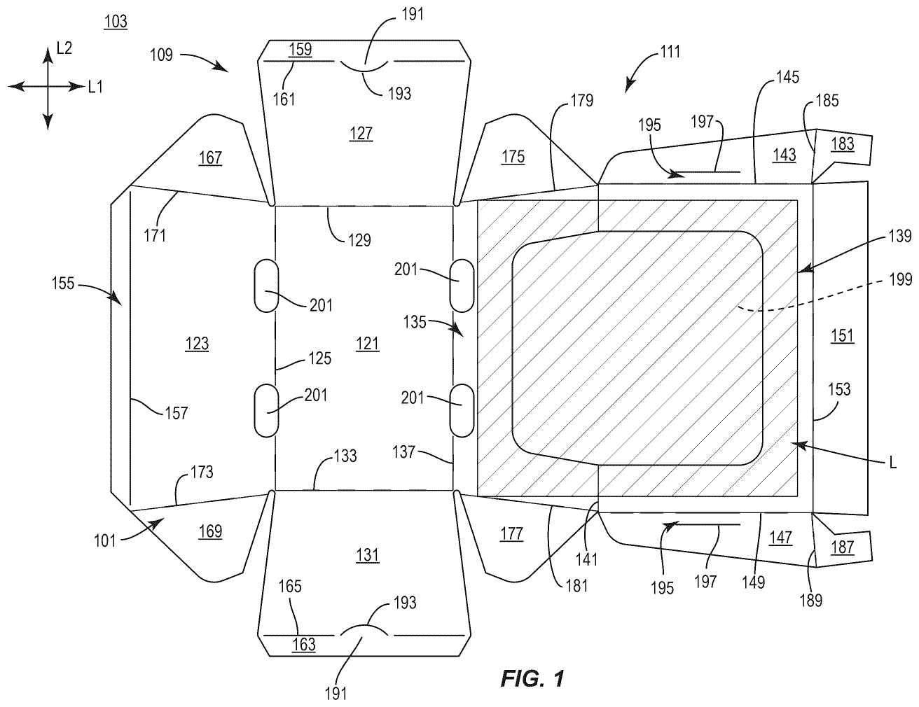

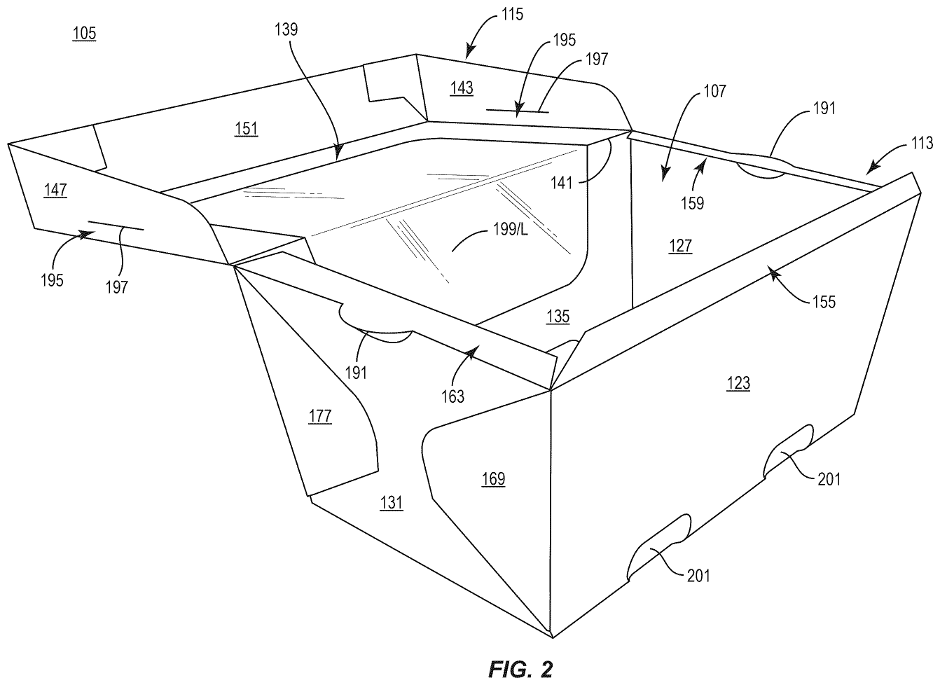

FIG. 1 is a plan view of an exterior surface 101 of a blank, generally indicated at 103, used to form a container assembly or tray 105 (FIG. 2) according to an exemplary embodiment of the disclosure.

As shown, the blank 103 has a longitudinal axis L1 and a lateral axis L2 and includes a base portion 109 for forming a base 113 of the tray 105, and a lid portion 111 for forming a lid 115 of the tray 105. In this regard, the lid portion 111 of the blank 103 is foldably connected to the base portion 109 of the blank 103 such that the lid 115 of the tray 105 is foldably connected to the base 113 of the tray 105 at a fold line 141, as described further herein.

The blank 103 includes plurality of panels for extending at least partially around an interior 107 of the tray 105 when the tray 105 is formed from the blank 103. The panels can include a base bottom panel 121, a base front panel 123 foldably connected to the base bottom panel 121 at a lateral fold line 125, a base first side panel 127 foldably connected to the base bottom panel 121 at a longitudinal fold line 129, a base second side panel 131 foldably connected to the base bottom panel 121 at a longitudinal fold line 133, a base back panel 135 foldably connected to the base bottom panel 121 at a lateral fold line 137, a lid top panel 139 foldably connected to the base back panel 135 at the lateral fold line 141, a lid first side panel 143 foldably connected to the lid top panel 139 at a longitudinal fold line 145, a lid second side panel 147 foldably connected to the lid top panel 139 at a longitudinal fold line 149, and a lid front panel 151 foldably connected to the lid top panel 139 at a lateral fold line 153.

The blank 103 and the tray 105 formed therefrom can also include a plurality of end flaps foldably connected to a respective panel of the plurality of panels. As shown, the plurality of end flaps can include a front end flap 155 foldably connected to the base front panel 123 at a lateral fold line 157, a side end flap 159 foldably connected to the base side panel 127 at a longitudinal fold line 161, a side end flap 163 foldably connected to the base side panel 131 at a longitudinal fold line 165, attachment end flaps 167, 169 foldably connected to the base front panel 123 at respective oblique fold lines 171, 173, attachment end flaps 175, 177 foldably connected to the base back panel 135 at respective oblique fold lines 179, 181, an attachment end flap 183 foldably connected to the lid side panel 143 at an oblique fold line 185, and an attachment end flap 187 foldably connected to the lid side panel 147 at an oblique fold line 189.

In the illustrated embodiment, the base portion 109 of the blank 103 can include the one or more of the panels 121, 123, 135, 127, 131 and associated end flaps, and the lid portion 111 of the blank 103 can include the one or more of the panels 135, 139, 143, 147, 151 and associated end flaps, though it will be understood that the base portion 109 and lid portion 111 of the blank 103 can be differently arranged without departing from the disclosure.

As described herein, the interior 107 of the tray 105 is generally formed by the base 113 extending therearound. However, it will be understood that the interior 107 of the tray 105 can include additional space at least partially defined by the lid 115, for example, when the tray 105 is in a closed configuration.

In some embodiments, the blank 103 and the tray 105 formed therefrom can include locking features for at least partially maintaining a desired configuration of the tray 105. As shown, the locking features can include respective locking tabs 191 (broadly, “first locking tab” and “second locking tab”, respectively, or “male locking feature”, respectively) at least partially defined by respective curved cuts 193 that interrupt the respective fold lines 163, 165 so as to protrude from respective portions of the respective side end flaps 159, 163.

The locking features can also respective locking regions 195 (broadly, “first locking region” and “second locking region”, respectively, or “female locking feature”, respectively) at least partially defined adjacent a respective longitudinal line of weakening 197 extending in each of the lid side panels 143, 147. As described herein, the locking regions 195 are configured to at least partially engage and/or receive the respective locking tabs 191 to facilitate maintenance of the tray 105 formed from the blank 103 in a closed configuration. In some embodiments, the locking regions 195 can be at least partially formed between the respective lines of weakening 197 and the respective fold line 145, 149. In some embodiments, the locking regions 195 can be otherwise formed.

The blank 103 and tray 105 formed therefrom can also include product visibility features that can include a window or opening 199 at least partially defined in each of the base back panel 135 and the lid top panel 139 so as to interrupt the fold line 141. As described further herein, the opening 199 can provide one or more lines of sight from an exterior environment to the interior 107 of the tray 105 formed from the blank 103 so as to facilitate inspection of the interior 107 of the tray 105 and/or one or more food products stored therein, for example, to entice the sale of such products, to facilitate quality control through visual inspection, etc.

In some embodiments, a liner L can be provided extending at least partially across and overlying the opening 199, for example, to provide a barrier between an exterior environment and the interior 107 of the tray 105 formed from the blank 103. In some embodiments, the liner L can be configured to maintain one or more properties associated with an interior environment in the interior 107 of the tray 105 formed from the blank 103, e.g., humidity, temperature, parts per volume of contaminants, etc.

In this regard, the liner L can be a sheet at least partially obscuring the opening 199, such as a sheet formed from polymeric, composite, and/or metallic materials. In some embodiments, the liner L can be a cellophane sheet. In this regard, the liner L can be formed of an at least partially transparent material so as to facilitate visibility into the interior 107 of the tray 105. In some embodiments, the liner L can be attached to the exterior surface 101 or to an interior surface of the blank 103, for example, with an adhesive such as glue.

With continued reference to FIG. 1, the blank 103 and tray 105 formed therefrom can also include openings 201 at least partially defined in respective portions of the base bottom panel 121, the base front panel 123, and the base back panel 135. In some embodiments, the openings 201 can facilitate the flow of one or more fluids between an exterior environment and the interior 107 of the tray 105 formed from the blank 103, for example, to provide for drainage of runoff and/or condensation, to provide ventilation, etc.

As described herein, the base 113 and the lid 115 of the tray 105 can be formed such that the lid 115 can be reconfigurable/repositionable between a closed configuration, in which the lid 115 at least partially overlies the interior 107 of the tray 105, and an open configuration, in which the lid 115 is raised away from the base 113, e.g., via hingable folding at the fold line 141.

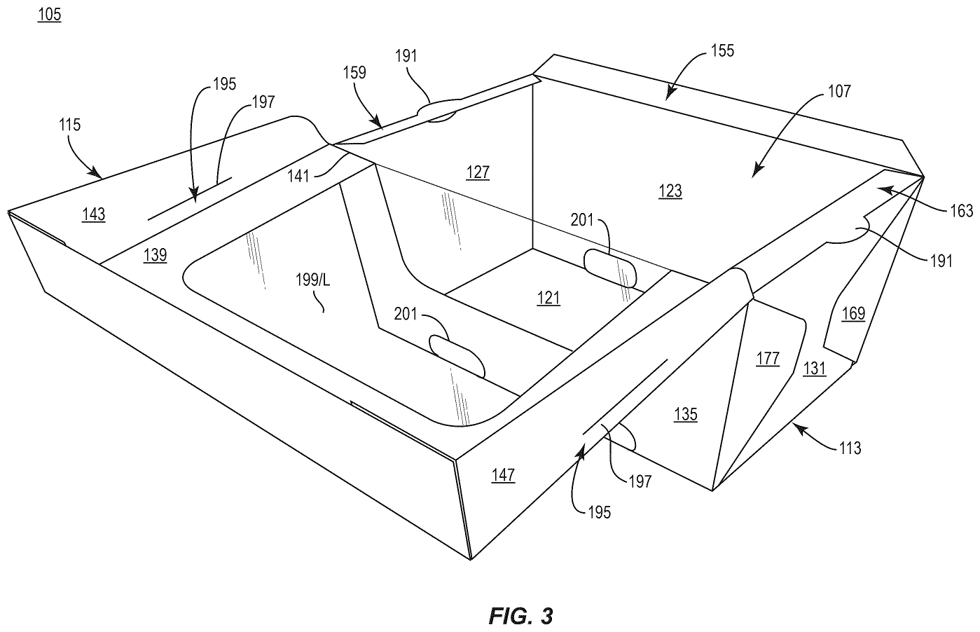

With additional reference to FIGS. 2 and 3, formation of the tray 105 from the blank 103 will be described according to an exemplary embodiment of the disclosure.

In some embodiments, the blank 103 can be inverted, e.g., such that the exterior surface 101 thereof is positioned at least partially contacting a supporting surface and such that an interior surface thereof (e.g., opposite the exterior surface 101) is positioned facing upwardly.

In order to at least partially form the base 113 of the tray 105, the base front panel 123, the base side panels 127, 131, and the base back panel 135 can be folded at the respective fold lines 125, 129, 133, 137 into at least partial upright relation relative to the bottom panel 121 and extending at least partially around the interior 107 thereof. In some embodiments, one or more of the panels 123, 127, 131, 135 can be at least partially obliquely arranged relative to the bottom panel 121 so as to provide an at least partially tapered profile of the tray 105.

The attachment end flaps 167, 169 can be folded at the fold lines 171, 173 into at least partial face-to-face contact with the side panels 127, 131. Similarly, the attachment end flaps 175, 177 can be folded at the fold lines 179, 181 into at least partial face-to-face contact with the side panels 127, 131.

In addition, the end flaps 159, 163 can be folded at the respective fold lines 161, 165 inwardly toward the interior 107 of the tray 105 and such that the locking tabs 191 at least partially separate from the respective base side panels 127, 131 at the respective cuts 193 so as to extend outwardly from the base 113, e.g., away from the interior 107 of the tray 105. In such an arrangement, the end flaps 159, 163 can be positioned in a generally planar and parallel arrangement with respect to the base bottom panel 121, with the respective locking tabs 191 extending planarly outwardly therefrom.

In some embodiments, the end flap 155 can be folded at the fold line 157 either toward the interior 107 of the tray 105 or away from the interior 107 of the tray 105, e.g., so as to be positioned in generally parallel and planar arrangement with the bottom panel 121.

In order to at least partially form the lid 115 of the tray 105, the lid side panels 143, 147 and the lid front panel 151 can be folded generally downwardly relative to the lid top panel 139 at the respective fold lines 145, 149, 153. In addition, the attachment end flaps 183, 187 can be folded at the respective fold lines 185, 189 into at least partial face-to-face contact with the lid front panel 151.

It will be understood that the aforementioned configuration of the tray 105 can be at least partially maintained via one or more applications of an adhesive such as glue, for example, on one or more of the attachment end flaps 167, 169, 175, 183, 187.

An open configuration of the tray 105 is illustrated in FIGS. 2 and 3, in which the lid 115 is in an open position at least partially raised away from the interior 107 of the tray 105.

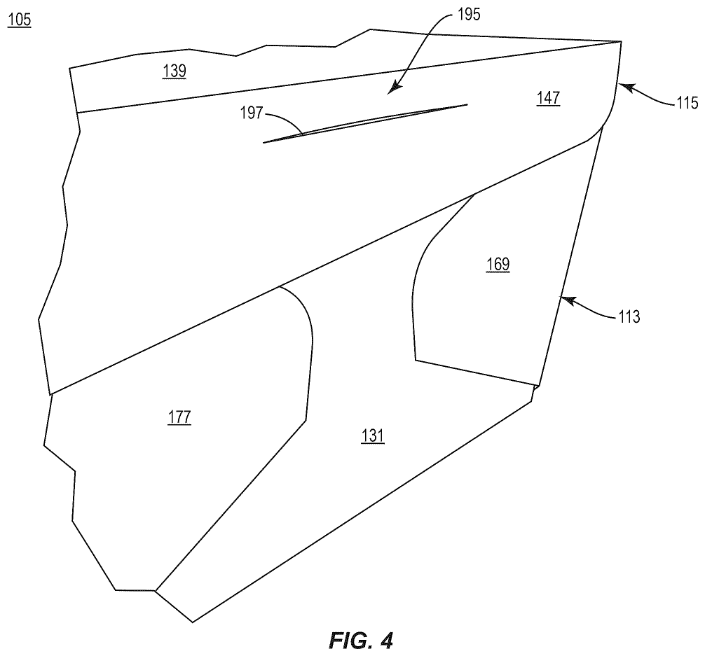

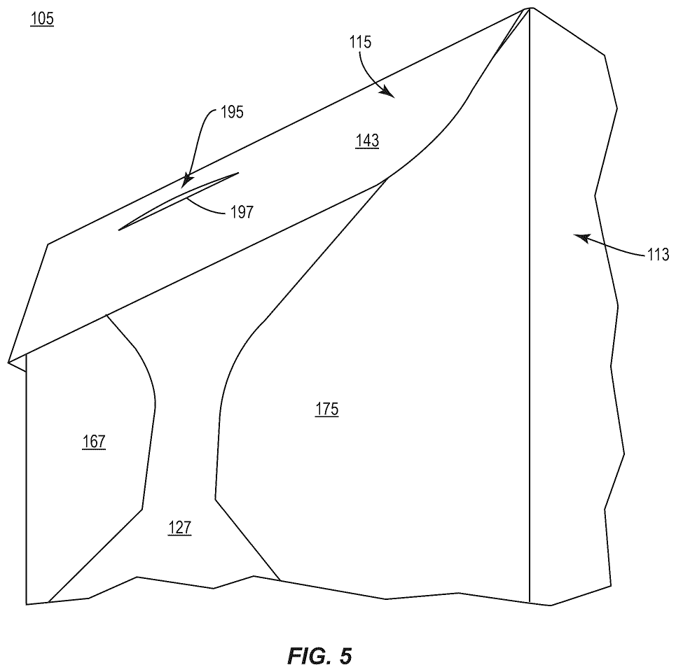

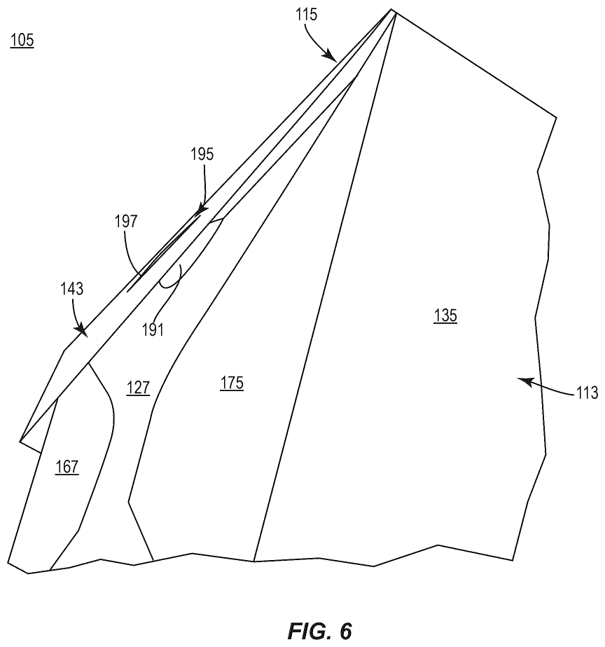

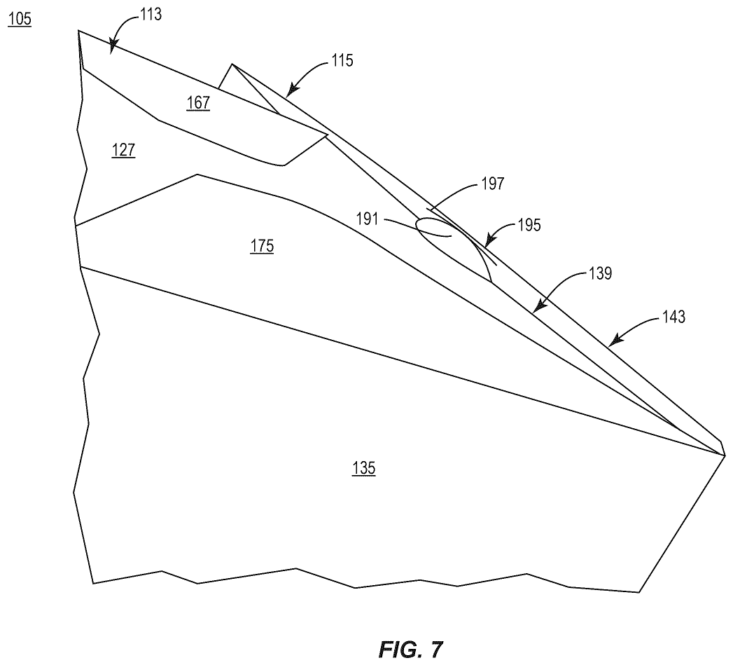

With additional reference to FIGS. 4-7, the lid 115 can be repositioned/reconfigured toward a closed position via folding at the fold line 141 such that the lid 115 at least partially overlies the interior 107 of the tray 105, to provide a closed configuration of the tray 105. In some embodiments, one or more edges or surfaces of the respective panels of the lid 115 can contact one or more respective edges or surfaces of the respective panels of the base 113 in the closed position.

In the illustrated arrangement, the interior surfaces of the lid side panels 143, 147 can be positioned to cam over, e.g., via slidable engagement, the respective locking tabs 191 as the lid 115 is transitioned to the closed position.

As the respective locking tabs 191 extend outwardly to a distance wider than in the lateral direction L2 along which the lid side panels 143, 147 are generally positioned, e.g., proximate the respective fold lines 145, 149, the camming action of the lid side panels 143, 147 over the free edges of the locking tabs 191 can cause at least partial deformation thereof.

In the illustrated embodiment, the configuration and arrangement of the respective lines of weakening 197 can facilitate the at least partial separation of the locking regions 195 away from the remainder of the respective lid side panel 143, 147, which can result of an at least partial bowing of the respective locking region 195 under the protruding influence of the respective locking tab 191 underneath or therebehind, e.g., extending from the respective side panel 127, 131 toward the interior surface thereof. In this regard, the locking regions 195 can be activated by the respective locking tabs 191 so as to have a generally bowed profile.

Furthermore, the configuration of the respective lines of weakening 197 can be such that the respective locking regions 195 resist the aforementioned movement away from the remainder of the respective lid side panel 143, 147 so as to exert a compressive force against the locking tabs 191 that tends to enhance static and/or dynamic frictional contact between the free edges of the locking tabs 191 and the free edges of the respective locking tabs 191 that can facilitate maintenance of the lid 115 in the closed position/closed configuration of the tray 105.

In such an arrangement, the respective locking tabs 191 can be generally obscured or hidden from view from an exterior perspective of the tray 105 due to the positioning thereof between interior surfaces of the lid 115 and the base 113 of the tray 105. Such position of the locking tabs 191 and the locking regions 195 can provide a streamlined profile that can not only be aesthetically pleasing, but that can also minimize outwardly extending structures that might otherwise interfere with shipping, storage, placement, etc. of the tray 105.

In some embodiments, the lines of weakening 197 can be positioned a distance along the lateral direction L2 about 0.25 inch from the respective fold lines 145, 149 and the locking tabs 191 can be positioned a distance along the lateral direction L2 about 3.061 inch from the respective fold lines 129, 133 to facilitate such engagement of the locking tabs 191 and locking regions 195. It will be understood that the locking features of the blank 103/tray 105 can be differently configured and/or arranged without departing from the disclosure.

When it is desired to reconfigure the tray 105 from the closed configuration to the open configuration/reposition the lid 115 from the closed position to the open position, the lid 115 can be engaged, for example, by a user contacting one or more surfaces or edges thereof, and the lid 115 can be lifted away from the base 113 such that the lid 115 at least partially folds relative to the base 113 at the fold line 141.

Such movement of the lid 115 can cause the interior surfaces of the lid side panels 143, 147 to slide along the free edges of the locking tabs 191 until disengagement thereof. In some embodiments, the locking tabs 191 can be at least partially bent or folded relative to the respective side panels 127, 131 to facilitate such disengagement from the lid 115. In some embodiments, the locking regions 195 can return to a generally planar arrangement with respect to the remainder of the lid panels 143, 147 upon disengagement from the locking tabs 191.

The tray 105 is thus provided with a repositionable lid 115 that can be at least partially maintained in a closed position with locking features that are at least partially obscured by the configuration and arrangement of the lid 115 so as to provide an aesthetically pleasing and/or streamlined profile.

It will be understood that one or more portions of the tray 105 can have a different configuration without departing from the disclosure.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the trays, to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure tray panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding one or more food products, comprising:
a base at least partially extending around an interior of the tray, the base comprising a base bottom panel, at least one base side panel, a base back panel, and a base front panel; and
a lid foldably connected to the base such that the lid is repositionable between an open position and a closed position, the lid comprising a top panel, at least one lid side panel, and a lid front panel, and locking features for at least partially maintaining the closed position of the lid, the locking features comprising a locking tab extending from the at least one base side panel and a line of weakening in the at least one lid side panel at least partially defining a locking region for engaging the at least one locking tab.

2. The tray of claim 1, wherein, when the lid is in the closed position, the locking tab causes the locking region to at least partially separate from the remainder of the at least one lid side panel.

3. The tray of claim 2, wherein, when the lid is in the closed position, the locking tab causes the locking region to have a bowed profile.

4. The tray of claim 3, wherein the tray comprises a plurality of end flaps foldably connected to a respective panel of the plurality of panels, the plurality of end flaps comprising a side end flap foldably connected to the at least one base side panel, the at least one locking tab planarly extending from the side end flap.

5. The tray of claim 4, wherein the side end flap is folded inwardly toward the interior of the tray relative to the at least one base side panel.

6. The tray of claim 5, wherein the lid top panel is foldably connected to the back top panel at a fold line interrupted by an opening at least partially formed in each of the base back panel and the lid top panel.

7. The tray of claim 6, further comprising a liner at least partially overlying the opening.

8. The tray of claim 1, wherein the at least one base side panel is a first base side panel, the at least one lid side panel is a first lid side panel, the at least one locking tab is a first locking tab, the locking region is a first locking region in the first lid side panel, the plurality of panels further comprises a second base side panel and a second lid side panel, and the locking features further comprise a second locking tab and a second locking region in the second lid side panel.

9. A blank for forming a tray for holding one or more food products, comprising:
a base portion for forming a base at least partially extending around an interior of the tray formed from the blank, the base portion comprising a base bottom panel, at least one base side panel, a base back panel, and a base front panel; and
a lid portion foldably connected to the base for forming a lid when the tray is formed from the blank such that the lid is repositionable between an open position and a closed position, the lid comprising a top panel, at least one lid side panel, and a lid front panel, and locking features for at least partially maintaining the closed position of the lid when the tray is formed from the blank, the locking features comprising a locking tab extending from the at least one base side panel and a line of weakening in the at least one lid side panel at least partially defining a locking region for engaging the at least one locking tab.

10. The blank of claim 9, wherein, when the lid of the tray formed from the blank is in the closed position, the locking tab causes the locking region to at least partially separate from the remainder of the at least one lid side panel.

11. The blank of claim 10, wherein, when the lid of the tray formed from the blank is in the closed position, the locking tab causes the locking region to have a bowed profile.

12. The blank of claim 11, wherein the blank comprises a plurality of end flaps foldably connected to a respective panel of the plurality of panels, the plurality of end flaps comprising a side end flap foldably connected to the at least one base side panel, the at least one locking tab planarly extending from the side end flap.

13. The blank of claim 12, wherein the lid top panel is foldably connected to the back top panel at a fold line interrupted by an opening at least partially formed in each of the base back panel and the lid top panel.

14. The blank of claim 13, further comprising a liner at least partially overlying the opening.

15. The blank of claim 9, wherein the at least one base side panel is a first base side panel, the at least one lid side panel is a first lid side panel, the at least one locking tab is a first locking tab, the locking region is a first locking region in the first lid side panel, the plurality of panels further comprises a second base side panel and a second lid side panel, and the locking features further comprise a second locking tab and a second locking region in the second lid side panel.

16. A method of forming a tray for holding one or more food products, comprising:
obtaining a blank, the blank comprising a base portion comprising a base bottom panel, at least one base side panel, a base back panel, and a base front panel, the blank further comprising a lid portion foldably connected to the base portion, the lid portion comprising a top panel, at least one lid side panel, and a lid front panel, the blank further comprising locking features comprising a locking tab extending from the at least one base side panel and a line of weakening in the at least one lid side panel at least partially defining a locking region;
forming a base from the base portion of the blank such that the base extends at least partially extending around an interior of the tray; and
forming a lid from the lid portion of the blank such that the lid is repositionable between an open position and a closed position, and such that the locking region is positionable for engaging the at least one locking tab for at least partially maintaining the closed position of the lid.

17. The method of claim 16, wherein, when the lid is in the closed position, the locking tab causes the locking region to at least partially separate from the remainder of the at least one lid side panel.

18. The method of claim 17, wherein, when the lid is in the closed position, the locking tab causes the locking region to have a bowed profile.

19. The method of claim 18, wherein the blank comprises a plurality of end flaps foldably connected to a respective panel of the plurality of panels, the plurality of end flaps comprising a side end flap foldably connected to the at least one base side panel, the at least one locking tab planarly extending from the side end flap.

20. The method of claim 19, further comprising folding the side end flap inwardly toward the interior of the tray relative to the at least one base side panel.

21. The method of claim 20, wherein the lid top panel is foldably connected to the back top panel at a fold line interrupted by an opening at least partially formed in each of the base back panel and the lid top panel.

22. The method of claim 21, further comprising positioning a liner at least partially overlying the opening.

23. The method of claim 16, wherein the at least one base side panel is a first base side panel, the at least one lid side panel is a first lid side panel, the at least one locking tab is a first locking tab, the locking region is a first locking region in the first lid side panel, the plurality of panels further comprises a second base side panel and a second lid side panel, and the locking features further comprise a second locking tab and a second locking region in the second lid side panel.
